(19) United States
(12) Patent Application Publication
(10) Pub. No.: US 2015/0062239 A1
(43) Pub. Date: Mar. 5, 2015

(54) Liquid Ejecting Apparatus and Control Method for Liquid Ejecting Apparatus

(71) Applicant: Seiko Epson Corporation, Tokyo (JP)

(72) Inventors: Toshihiko Wakabayashi, Shiojiri-shi (JP); Kazuyuki Fujioka, Matsumoto-shi (JP)

(21) Appl. No.: 14/462,948

(22) Filed: Aug. 19, 2014

(30) Foreign Application Priority Data
Aug. 28, 2013 (JP) 2013-177144

(51) Int. Cl. B41J 2/165

(52) U.S. Cl. CPC B41J 2/16541
USPC 347/23; 347/33

(57) ABSTRACT

A liquid ejecting apparatus includes an ejection head capable of ejecting a solution, a rotating member having an outer surface capable of receiving the solution ejected from the ejection head, and a scraper that wipes off the solution adhering to the outer surface by sliding along the outer surface when the rotating member rotates, the rotating member carrying out a first rotational operation of rotating after flushing, in which the ejection head ejects the solution toward the outer surface, has been performed, and a second rotational operation of rotating from when the first rotational operation ends to when the next flushing is executed.

### CROSS REFERENCE TO RELATED APPLICATION

This application claims priority under 35 U.S.C. §119 on Japanese Patent Application No. 2013-177144, filed Aug. 28, 2013 and is hereby incorporated by reference in its entirety

### BACKGROUND

1. Technical Field

The present invention relates to liquid ejecting apparatuses such as printers and to control methods for liquid ejecting apparatuses.

2. Related Art

Ink jet printers that print by ejecting ink from a nozzle onto a medium such as paper have been known for some time as an example of a liquid ejecting apparatus. Some such printers include a rotating member that receives ink and a wiping portion disposed so as to make contact with an outer surface of the rotating member, and carry out flushing that ejects ink toward the outer surface of the rotating member in order to suppress the nozzle from clogging.

When a set amount of ink has adhered to the outer surface of the rotating member as a result of the flushing, the ink is wiped off from the rotating member by rotating the rotating member so that the wiping portion slides along the outer surface to which the ink has adhered (see JP-A-2001-162836, for example).

Incidentally, in the stated printer, although the adhering ink is wiped off by the wiping portion by rotating the rotating member each time the set amount of ink has adhered, it is difficult to completely remove the adhering ink. Accordingly, there is a problem in that remaining ink that could not be removed will harden and accumulate on the surface of the rotating member, and the wiping portion will become unable to wipe off that hardened ink.

Note that such a problem is not limited to printers having rotating members that receive ink, but is generally a common problem among liquid ejecting apparatuses that employ rotating members to receive solutions whose solute components may harden.

### SUMMARY

It is an advantage of some aspects of the invention to provide a liquid ejecting apparatus capable of suppressing the accumulation of a solution that adheres to a rotating member, and to provide a control method for such a liquid ejecting apparatus.

A summary of aspects of the invention for achieving the aforementioned advantage, and of effects of the invention, will be described below.

A liquid ejecting apparatus according to an aspect of the invention includes an ejection head capable of ejecting a solution, a rotating member having an outer surface capable of receiving the solution ejected from the ejection head, and a scraper that wipes off the solution adhering to the outer surface by sliding along the outer surface when the rotating member rotates, the rotating member carrying out a first rotational operation of rotating after flushing, in which the ejection head ejects the solution toward the outer surface, has been performed, and a second rotational operation of rotating from when the first rotational operation ends to when the next flushing is executed.

According to this aspect, the solution adhering to the outer surface as a result of the flushing can be removed by the first rotational operation of the rotating member. Note that the solution that has just adhered to the outer surface due to the flushing sometimes flows between the scraper and the outer surface of the rotating member rotating due to the first rotational operation, with a thin layer thereof remaining on the outer surface; this remaining solution will begin to harden as time passes. Accordingly, the solution not completely removed by the first rotational operation that remains on the outer surface and begins to harden can be removed by the second rotational operation of the rotating member, which is executed after the first rotational operation has ended but before the next flushing is executed. Accordingly, the solution adhering to the rotating member can be suppressed from accumulating.

In the above liquid ejecting apparatus, it is preferable that the rotating member carry out the second rotational operation when the liquid ejecting apparatus is turned on.

According to this aspect, solution that is not completely removed by the first rotational operation and remains on the outer surface after flushing and that begins to harden while the power is turned off can be removed by the rotating member carrying out the second rotational operation when the power is turned on. Meanwhile, although the solution not completely removed by the first rotational operation often adheres and begins to harden at the point of contact between the outer surface and the scraper, causing the rotating member to carry out the second rotational operation when the power is turned on separates the scraper and the outer surface from each other. This makes it possible to rotate the rotating member in a smooth manner when the first rotational operation is carried out after the next flushing.

It is preferable that the above liquid ejecting apparatus further include a receptacle having an opening in a position that opposes the outer surface; the solution wiped off from the outer surface by the scraper be held in the receptacle via the opening; and as the first rotational operation, the rotating member rotate until at least a region that opposed the ejection head during the flushing passes the scraper, and as the second rotational operation, the rotating member rotate until a region that opposed the opening at the end of the first rotational operation reaches a position opposing the ejection head.

According to this aspect, in the first rotational operation performed after the flushing, the rotating member rotates until the region that opposed the ejection head during the flushing passes the scraper, and thus the solution ejected from the ejection head and adhering to the outer surface can be removed by the scraper and held in the receptacle. Furthermore, in the second rotational operation, the rotating member is rotated until the region that opposed the opening when the first rotational operation ended reaches a position opposing the ejection head, and thus during the next flushing, the solution is ejected onto a region kept in a moist state by the solvent of the solution held in the receptacle. As a result, the solution adhering to the outer surface due to the next flushing can be removed with ease.

In the above liquid ejecting apparatus, it is preferable that the receptacle include a liquid reservoir portion capable of holding a liquid and an introduction portion for introducing a liquid in which a solute component of the solution can be dissolved into the liquid reservoir portion.

According to this aspect, when a liquid in which the solute component of the solution can dissolve enters into the liquid reservoir portion via the introduction portion, the amount of solvent component held in the receptacle increases. As a result, the interior of the receptacle is kept in a moist state by the solvent component, which in turn makes it possible to keep the outer surface of the rotating member that opposes the opening in a moist state.

In the above liquid ejecting apparatus, it is preferable that the introduction portion be disposed higher in a vertical direction than the liquid reservoir portion, and the rotating member carry out a third rotational operation of rotating when the liquid enters the receptacle.

If the introduction portion is disposed higher in the vertical direction than the liquid reservoir portion, the liquid that enters into the receptacle via the introduction portion will fall onto the liquid surface formed in the liquid reservoir portion, and the solution may form foam that then overflows from the opening. With respect to this point, according to this aspect, the rotating member rotates when the liquid enters the receptacle, and thus foam that has reached the opening adheres to the outer surface of the rotating member. Foam that adheres to the outer surface can be eliminated and the resulting liquid returns to the receptacle by being wiped off by the scraper as the rotating member rotates. As a result, foam produced when the liquid enters can be suppressed from overflowing from the receptacle.

### BRIEF DESCRIPTION OF THE DRAWINGS

The invention will be described with reference to the accompanying drawings, wherein like numbers reference like elements.

FIG. 1 is a cross-sectional view illustrating the overall configuration of a liquid ejecting apparatus according to an embodiment.

FIG. 2 is a cross-sectional view taken along a II-II line shown in FIG. 1.

FIG. 3 is a flowchart illustrating steps of a process carried out when a rotating member makes a first rotational operation.

FIG. 4 is a flowchart illustrating steps of a process carried out when a rotating member makes a second rotational operation.

FIG. 5 is a flowchart illustrating steps of a process carried out when a rotating member makes a third rotational operation.

### DESCRIPTION OF EXEMPLARY EMBODIMENTS

Hereinafter, an embodiment of a liquid ejecting apparatus capable of ejecting a solution will be described with reference to the drawings.

The liquid ejecting apparatus is an ink jet printer that prints by ejecting ink, which is an example of a solution, onto paper, which is an example of a medium.

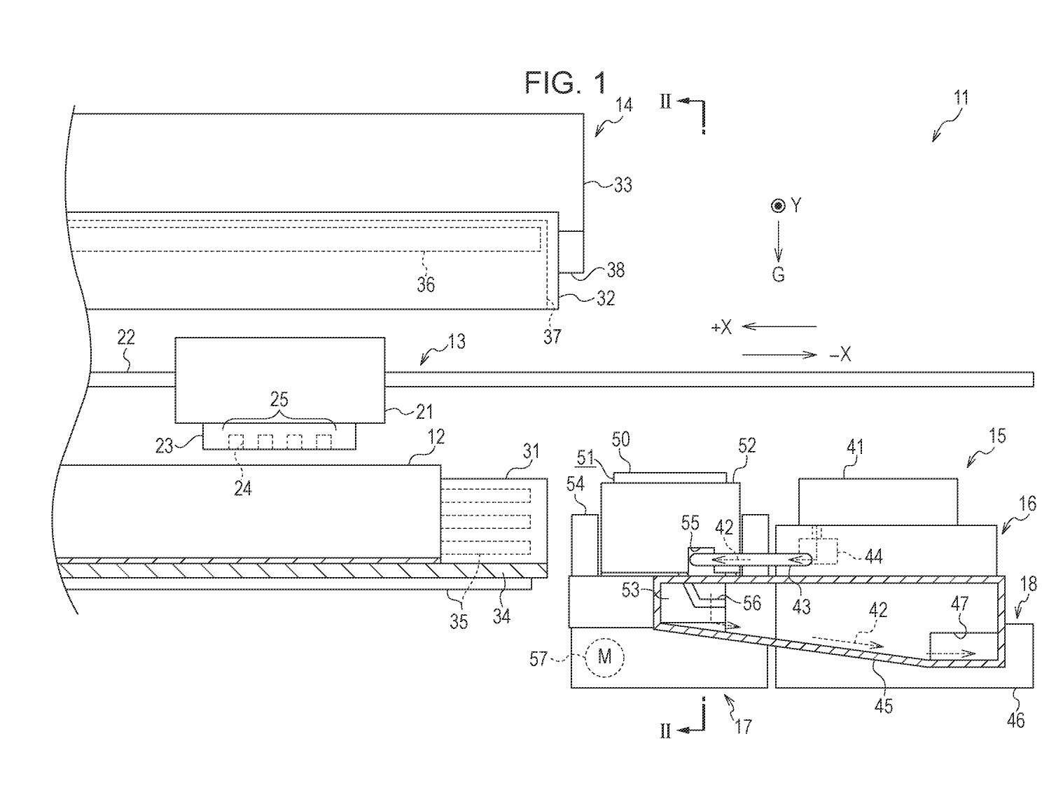

As shown in FIG. 1, a liquid ejecting apparatus 11 according to this embodiment includes an ejecting unit 13 that ejects a solution onto a medium 12, a drying unit 14 for drying the medium 12 that has received the solution, and a maintenance unit 15 that performs maintenance on the ejecting unit 13.

The solution ejected by the ejecting unit 13 is, for example, a water-based resin ink that employs water as a solvent and a resin-based pigment as a solute. It is preferable for the solution to substantially not contain glycerin having a boiling point of 290° C. at 1 atmospheric pressure.

Note that if the solution substantially contains glycerin, the drying properties of the solution will drop significantly. As a result, the medium 12 that has received the solution will not dry sufficiently, which in turn causes unevenness in the darkness of images, poor fixing of the solute to the medium 12, and so on. Such a tendency becomes particularly prominent in the case where a medium 12 having low solution absorbency, a medium 12 having almost no solution absorbency, or the like is used. Furthermore, it is preferable for the solution ejected by the ejecting unit 13 to substantially not contain alkylpolyol-based materials (aside from the stated glycerin) having boiling points of 280° C. or more at the equivalent of 1 atmospheric pressure.

In this specification, the phrase “substantially not containing” refers to not containing greater than or equal to an amount that sufficiently encompasses the meaning of addition. Quantitatively speaking, it is preferable for 1.0 or more mass % of glycerin relative to the total mass (100 mass %) of the solution not to be contained. It is further preferable for 0.5 or more mass % of glycerin relative to the total mass of the solution not to be contained, further preferable still for 0.1 or more mass % not to be contained, further preferable still for 0.05 or more mass % not to be contained, and particularly preferable for 0.01 or more mass % not to be contained. It is most preferable for 0.001 or more mass % of glycerin relative to the total mass of the solution not to be contained.

Next, the configuration of the ejecting unit 13 will be described.

The ejecting unit 13 includes a carriage 21 capable of moving back and forth along a guide shaft 22 that extends in a movement direction X (+X and −X) and an ejection head 23 capable of ejecting the solution.

With a first end side in the movement direction X (the right end side, in FIG. 1) serving as a home position, the carriage 21 moves back and forth along the movement direction X by alternating between an outbound pass of moving from the home position in the movement direction +X (to the left, in FIG. 1) and an inbound pass of moving in the movement direction −X (to the right, in FIG. 1).

In a movement region extending in the movement direction X of the carriage 21, a central area excluding both sides in the movement direction X serves as a printing region where the solution is ejected onto the medium 12. Note that the medium 12 is transported along a transport direction Y, which is orthogonal to both the movement direction X of the carriage 21 and a gravitational direction G, by a transport mechanism (not shown).

The ejection head 23 is held by the carriage 21. A plurality of nozzles 24 for ejecting the solution are provided in the ejection head 23. The plurality of nozzles form nozzle rows 25 that are arranged in the transport direction Y. A plurality (for example, four) nozzle rows 25 are disposed in accordance with the types, such as the colors, of the solution. Printing is carried out by the ejection head 23 ejecting the solution from each of the nozzle rows 25 onto the medium 12 in a superimposed manner while the carriage 21 moves back and forth in the movement direction X.

Next, the configuration of the drying unit 14 will be described.

The drying unit 14 is disposed in a position along the movement direction X that corresponds to the printing region. The drying unit 14 includes a heating unit 31 disposed lower than the carriage 21 in the gravitational direction G, and a thermal unit 32 and a blower unit 33 disposed higher than the carriage 21 in the gravitational direction G.

The heating unit 31 includes a support platform 34 that supports the medium 12 on a front surface side of the support platform 34, and a heater 35 disposed on a rear surface side of the support platform 34. The support platform 34 is configured of, for example, a metal plate that extends in the transport direction Y, and conducts heat from the heater 35 to the medium 12.

It is preferable for the support platform 34 to be tilted downward from a position corresponding to the movement region of the carriage 21 toward the upstream side and downstream side in the transport direction Y, so that wrinkles are not formed in the medium 12. Note that in this embodiment, the downstream side in the transport direction Y is sometimes referred to as the “front side”. As such, FIG. 1 is a cross-sectional view of the liquid ejecting apparatus 11 taken from the front side.

The heater 35 primarily serves to heat the medium from the rear surface side thereof in order to fix the pigment, which is the solute in the solution that has adhered to the medium 12. Accordingly, it is preferable for the heater 35 to be disposed downstream from the printing region in the transport direction Y.

The thermal unit 32 includes a heating element 36 and a reflecting plate 37 disposed so as to cover the heating element 36 from above. The heating element 36 is an infrared heater, for example, and the thermal unit 32 prompts the vaporization of the solvent component in the solution that has adhered to the medium 12 (water, for example) using radiant heat from the infrared rays radiated from the heating element 36 and the infrared rays reflected by the reflecting plate 37.

The blower unit 33 includes a blower port 38 through which air is blown toward the support platform 34. In order to accelerate the drying of the medium 12, the blower unit 33 blows air toward the medium 12 upon the support platform 34 and disperses the vaporized solvent component.

Next, the configuration of the maintenance unit 15 will be described.

The maintenance unit 15 is disposed at a first end side (the right end side, in FIG. 1) of the movement region of the carriage 21.

The maintenance unit 15 includes a suction mechanism 16 that sucks the solution from the ejection head 23, a flushing unit 17 that receives the solution ejected from the ejection head 23, and a waste liquid collection unit 18 that collects the solution discharged from the ejection head 23 as waste liquid.

Note that an operation of the ejection head 23 that ejects the solution toward the flushing unit 17 in order to suppress the nozzles 24 from clogging and so on is referred to as “flushing”. By sucking and discharging the solution in the ejection head 23 through the nozzles 24, the suction mechanism 16 cleans the ejection head 23 through suction. The solution discharged from the ejection head 23 when maintenance such as flushing, suction cleaning, or the like is performed on the ejection head 23 is referred to as “waste liquid”.

The suction mechanism 16 includes a cap 41, an introduction flow channel 43 that forms a waste liquid collection flow channel 42 whose upstream end opens into a base area of the cap 41, and a suction pump 44 disposed partway along the introduction flow channel 43. The introduction flow channel 43 is a flexible tube, for example, and the suction pump 44 is a tube pump that produces a negative pressure within the cap 41 by compressing the tube in one direction, for example.

When the ejection head 23 is not ejecting the liquid, the carriage 21 is stopped at the home position, which is set above the suction mechanism 16. The cap 41 is raised upward when the carriage 21 is positioned at the home position, and makes contact with the ejection head 23 so as to surround the nozzles 24. As a result, the cap 41 caps the ejection head 23 and suppresses the nozzles 24 from drying.

When the suction pump 44 is driven while the ejection head 23 is capped by the cap 41, the solution within the ejection head 23 is sucked through the nozzles 24 and discharged through the introduction flow channel 43.

The flushing unit 17 includes a rotating member 51 having an outer surface 50 capable of receiving the solution ejected from the ejection head 23, a holding frame 52 that holds the rotating member 51 in a rotatable state, a receptacle 53 disposed below the holding frame 52, a mounting portion 54, and a flushing motor 57 serving as a driving source for rotating the rotating member 51.

The waste liquid collection unit 18 includes a discharge flow channel 45 disposed relative to the receptacle 53 and the suction mechanism 16 so as to be arranged on a side in a direction intersecting with the gravitational direction G (on the downstream side in the transport direction Y, which is the front side in this embodiment), and a waste liquid tank 46 disposed below the suction mechanism 16. The discharge flow channel 45 forms part of the waste liquid collection flow channel 42 on the downstream side thereof. The discharge flow channel 45 communicates with the waste liquid tank 46 via a communication opening 47.

An introduction portion 55 into which a downstream end of the introduction flow channel 43 is inserted is formed as a cutout in a front surface side of the holding frame 52. Meanwhile, a liquid outflow port 56 is formed in a front surface side of the receptacle 53, opening toward the discharge flow channel 45 side, and by extension, toward the waste liquid collection flow channel 42 side.

The liquid outflow port 56 is disposed in a position that is higher than the discharge flow channel 45 in the gravitational direction G. Note that the discharge flow channel 45 is slanted so as to slope downward from the side on which the liquid outflow port 56 is located, corresponding to the upstream side, toward the side on which the communication opening 47 is located, corresponding to the downstream side. Meanwhile, the introduction portion 55 of the holding frame 52 and the downstream end of the introduction flow channel 43 that is inserted into the introduction portion 55 are disposed higher than the liquid outflow port 56 in the gravitational direction G.

The receptacle 53 is provided partway along the waste liquid collection flow channel 42. Accordingly, the waste liquid discharged from the ejection head 23 by the suction mechanism 16 enters the receptacle 53 via the introduction flow channel 43. Furthermore, the waste liquid discharged from the receptacle 53 through the liquid outflow port 56 enters the waste liquid tank 46 via the discharge flow channel 45 and the communication opening 47.

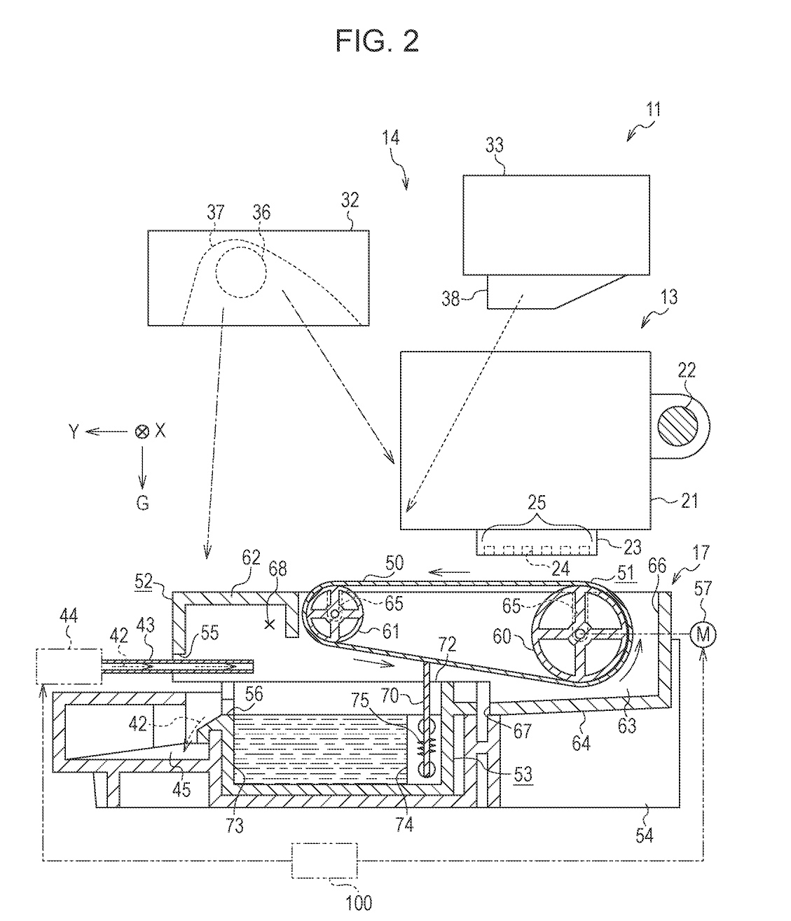

As shown in FIG. 2, the rotating member 51 is, for example, an endless belt wound upon rollers 60 and 61. The roller 60 is a driving roller that, under a driving force from the flushing motor 57, rotates in the counter-clockwise direction shown in FIG. 2. The roller 61, meanwhile, is a slave roller that rotates under the rotational force of the roller 60 and the rotating member 51. The roller 61 is smaller in diameter than the roller 60, and is disposed further toward the front side (the left side, in FIG. 2) than the roller 60.

The holding frame 52 has a box shape including an upper wall 62, a side wall 63, and a base wall 64. Note that the holding frame 52 is longer than the receptacle 53 in a direction following the transport direction Y (the horizontal direction, in FIG. 2).

Bearing portions 65 that hold the rollers 60 and 61 in a rotatable state are formed in the side wall 63 of the holding frame 52. An upper opening portion 66 for exposing the rotating member 51 is formed toward the rear side (the right side, in FIG. 2) of the upper wall 62. Furthermore, a lower opening portion 67 for mounting the receptacle 53 is formed toward the front side (the left side, in FIG. 2) of the base wall 64.

The receptacle 53 surrounds and forms a containment chamber 68 when mounted to the holding frame 52. A plate-shaped scraper 70 capable of sliding along the outer surface 50 of the rotating member 51 from below is contained within the containment chamber 68. In other words, the receptacle 53 and the holding frame 52 form the containment chamber 68 that surrounds the scraper 70 when mounted to the mounting portion 54, as illustrated in FIG. 2.

The receptacle 53 includes an opening 72 into which the scraper 70 can be inserted and a liquid reservoir portion 73 disposed below the opening 72 in the gravitational direction G and capable of holding the liquid. Note that the introduction portion 55 is disposed above the liquid reservoir portion 73 in the vertical direction so as to introduce the waste liquid into the liquid reservoir portion 73. In addition, the liquid outflow port 56 of the receptacle 53 is disposed between the opening 72 and the liquid reservoir portion 73 in the gravitational direction G.

In this embodiment, a lower-side portion of the rotating member 51 is disposed within the containment chamber 68, whereas an upper-side portion of the rotating member 51 is disposed at the outside of the containment chamber 68, through the upper opening portion 66. Of the lower-side portion of the rotating member 51 disposed within the containment chamber 68, a portion spanning from the center to the roller 61 in a depth direction is disposed so that the outer surface 50 opposes the opening 72 of the receptacle 53. Meanwhile, of the upper-side portion of the rotating member 51 disposed at the outside of the containment chamber 68, a portion spanning from the center to the roller 60 in the depth direction is disposed so as to oppose the ejection head 23. When the rotating member 51 makes 0.5 rotations, a region of the outer surface 50 that has been opposing the ejection head 23 moves to a location opposing the opening 72, while at the same time, a region of the outer surface 50 that has been opposing the opening 72 moves to a location opposing the ejection head 23.

The receptacle 53 includes, in a location toward the rear side thereof (the right side, in FIG. 2), a holding portion 74 that holds the scraper 70. The holding portion 74 includes a biasing member 75 that biases the scraper 70 upward in the gravitational direction G. The biasing member 75 is a coil spring, for example. The scraper 70 held by the holding portion 74 is pressed against the outer surface of the rotating member 51 by the biasing force of the biasing member 75. The scraper 70 slides along the outer surface 50 when the rotating member 51 rotates and removes the solution that adheres to the outer surface 50.

The liquid ejecting apparatus 11 includes a control unit 100 that controls the suction pump 44 and the flushing motor 57. The control unit 100 controls operation of the suction cleaning, which forcefully discharges liquid from the nozzles 24, by driving the suction pump 44 while the ejection head 23 is capped. Furthermore, the control unit 100 causes the rotating member 51 to rotate by controlling the driving of the flushing motor 57 to rotate the roller 60.

Next, operations of the liquid ejecting apparatus 11 configured as above will be described.

With the liquid ejecting apparatus 11, partway through printing, after suction cleaning, or the like, the carriage 21 is moved to a location above the flushing unit 17, and flushing, in which the ejection head 23 ejects the solution toward the outer surface 50 of the stopped rotating member 51, is carried out. When the flushing ends, the rotating member 51 is rotated and the solution adhering to the outer surface 50 is wiped off by the scraper 70.

Here, a rotation of the rotating member 51 carried out after flushing, in which the ejection head 23 ejects the solution toward the outer surface 50, will be referred to as a “first rotational operation”. In the first rotational operation, it is preferable to control the flushing motor 57 so that the rotating member 51 rotates at least until the region that opposed the ejection head 23 during the flushing passes the scraper 70. In this embodiment, the region of the rotating member 51 that opposed the ejection head 23 during flushing passes the scraper 70 and moves once again to the location opposing the ejection head 23 as a result of the rotating member 51 making a single rotation as the first rotational operation.

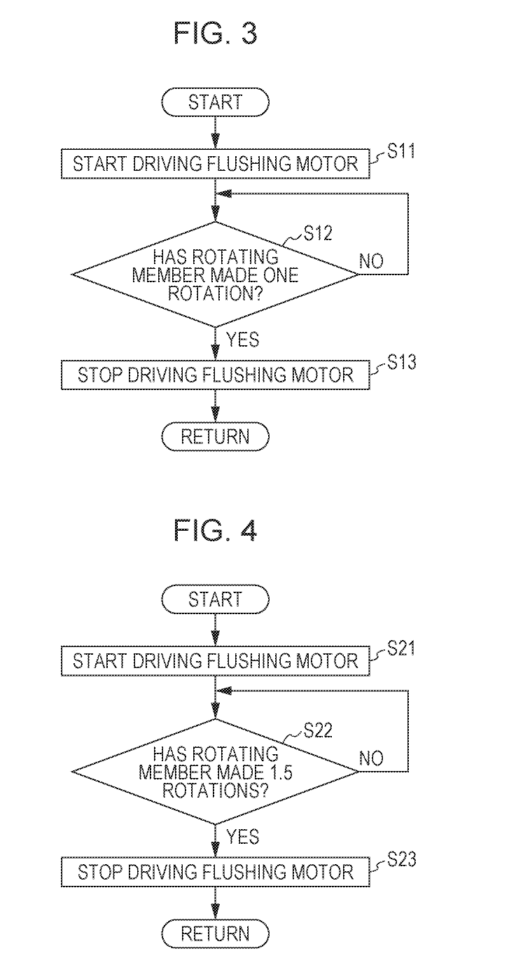

The rotating member 51 performs the first rotational operation when the control unit 100 makes processing of a first control routine be executed, illustrated in FIG. 3, when flushing has ended, for example.

As shown in FIG. 3, when the first control routine is started, first, in step S11, the control unit 100 starts driving the flushing motor 57.

Next, the process advances to step S12, where the control unit 100 determines whether or not the rotating member 51 has made a single rotation. In the case where it is determined in step S12 that the rotating member 51 has made a single rotation (step S12: YES), the process advances to step S13. In step S13, the control unit 100 stops driving the flushing motor 57.

On the other hand, in the case where a determination of “no” is made in step S12 (step S12: NO), the determination of step S12 is repeated. In other words, the flushing motor 57 continues to be driven until the rotating member 51 has made a single rotation.

Note that, for example, a counter that counts the rotational amount of the flushing motor 57 can be provided and whether or not the rotating member 51 has rotated by a predetermined amount (a single rotation, for example) can then be determined based on whether or not a value counted by the counter has reached a set value.

By sliding along the outer surface 50 of the rotating member 51 during the first rotational operation, the scraper 70 wipes off the solution that has adhered to the outer surface 50 of the rotating member 51 due to the flushing. The solution wiped off by the scraper 70 falls into the liquid reservoir portion 73 and is held in the receptacle 53. In other words, the receptacle 53 has the opening 72 in a location opposing the outer surface 50, and holds the solution wiped off from the outer surface 50 by the scraper 70.

As a second rotational operation, the rotating member 51 rotates from when the first rotational operation has ended to when the next flushing is executed. In other words, the rotating member 51 executes the second rotational operation after a predetermined amount of time has elapsed following the end of the first rotational operation. In this embodiment, the rotating member 51 performs the second rotational operation when the control unit 100 makes processing of a second control routine be executed, illustrated in FIG. 4, when the liquid ejecting apparatus 11 is turned on.

As shown in FIG. 4, when the second control routine is started, first, in step S21, the control unit 100 starts driving the flushing motor 57.

Next, the process advances to step S22, where the control unit 100 determines whether or not the rotating member 51 has made 1.5 rotations. In the case where it is determined in step S22 that the rotating member 51 has made 1.5 rotations (step S22: YES), the process advances to step S23. In step S23, the control unit 100 stops driving the flushing motor 57.

Note that in the second rotational operation, it is preferable for the rotating member 51 to rotate until a region that has been kept moist by opposing the opening 72 since the first rotational operation ended reaches a position opposing the ejection head 23. With respect to this point, when the second control routine illustrated in FIG. 4 is executed upon the liquid ejecting apparatus 11 being turned on, the region that opposed the opening 72 when the first rotational operation ended reaches the position opposing the ejection head 23 as a result of the rotating member 51 making 1.5 rotations.

Incidentally, the solution that has just adhered to the outer surface due to the flushing sometimes flows between the scraper 70 and the outer surface 50 of the rotating member 51 rotating due to the first rotational operation, with a thin layer thereof remaining on the outer surface 50; this remaining solution will begin to harden as time passes. It is particularly easy for the solution to accumulate at the point of contact between the scraper 70 and the outer surface 50.

When the second rotational operation is executed, the remaining solution that could not be removed during the first rotational operation has begun to harden and does not easily flow, and is accordingly wiped off by the scraper 70 sliding along the outer surface 50. Here, because the scraper 70 is biased by the biasing member 75, the solution hardening at the point of contact between the outer surface and the scraper 70 and so on can be wiped off by the rotating member 51 making 1.5 rotations.

Note that in the case where the flushing is carried out partway through printing, it is preferable to first eject the solution from the nozzle rows 25, which eject the solution that does not harden easily, when the carriage 21 makes the inbound pass in the movement direction −X from the printing region toward the home position. It is then preferable to eject the solution from the remaining nozzle rows 25, which eject the solution that hardens easily, when the carriage 21 moves in the movement direction +X from the home position side toward the printing region following the inbound pass.

In other words, causing the solution that does not harden easily to adhere to the outer surface 50 first makes it easy to remove the solution from the rotating member 51 when the scraper 70 slides thereon, even in the case where more solution has hardened on top of the solution that initially adhered thereto. Note that the number of nozzle rows 25 that eject the solution onto the outer surface 50 first can be set as desired.

Incidentally, in the liquid ejecting apparatus 11, the suction mechanism 16 carries out the suction cleaning and fills the ejection head 23 with new solution before, for example, the liquid is ejected. At this time, the solution sucked by the suction mechanism 16 and discharged from the ejection head 23 enters into the liquid reservoir portion 73 of the receptacle 53 via the introduction flow channel 43.

In other words, waste liquid solution enters the liquid reservoir portion 73 via the introduction flow channel 43 each time the solution is sucked from the ejection head 23. Furthermore, when the liquid surface of the solution that has accumulated in the liquid reservoir portion 73 reaches the liquid outflow port 56, the supernatant solution flows into the discharge flow channel 45 via the liquid outflow port 56.

If the introduction portion 55 is disposed above the liquid reservoir portion 73 in the vertical direction when the waste liquid enters the liquid reservoir portion 73, there arises a risk such that the waste liquid that enters into the receptacle 53 via the introduction portion 55 will fall onto the liquid surface formed in the liquid reservoir portion 73, and the solution may form foam that then overflows from the opening 72.

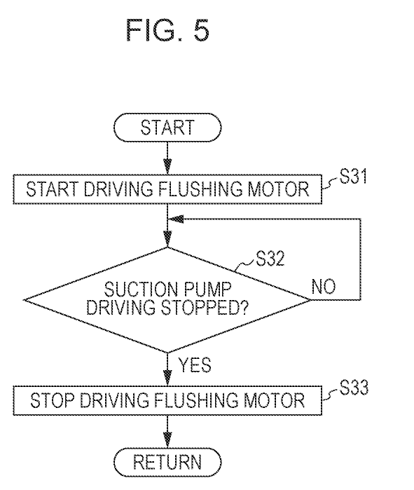

Accordingly, the rotating member 51 performs a third rotational operation for rotating when the solution enters the receptacle 53. For example, the rotating member 51 performs the third rotational operation when the control unit 5 makes processing of a third control routine be executed, illustrated in FIG. 5, when the driving of the suction pump 44 begins.

As shown in FIG. 5, when the third control routine is started, first, in step S31, the control unit 100 starts driving the flushing motor 57. Next, the process advances to step 532, where the control unit 100 determines whether or not the driving of the suction pump 44 has stopped. In the case where it is determined in step S32 that the driving of the suction pump 44 has stopped (step S32: YES), the process advances to step S33. In step S33, the control unit 100 stops driving the flushing motor 57.

On the other hand, in the case where a determination of “no” has been made in step S32 (step S32: NO), the determination of step S32 is repeated. In other words, the flushing motor 57 continues to be driven until the driving of the suction pump 44 stops. As a result, the rotating member 51 continues to rotate while the waste liquid is entering into the receptacle 53.

Accordingly, foam that has reached the opening 72 adheres to the outer surface 50 of the rotating member 51, and thus the foam can be eliminated and the resulting liquid returns to the receptacle 53 by being wiped off by the scraper 70 as the rotating member 51 rotates.

Note that the solution wiped off by the scraper 70 during the first rotational operation, the second rotational operation, and the third rotational operation falls into the liquid reservoir portion 73 and is held along with the unhardened liquid solution discharged from the ejection head 23. Here, the solution ejected from the ejection head 23 and the solution corresponding to the liquid held in the liquid reservoir portion 73 both contain water.

In other words, the liquid reservoir portion 73 holds a liquid in which the solute component of the solution can dissolve. Accordingly, solute components of the hardened solution dissolve once again in the water contained as the solvent in the solution (liquid) having been discharged as waste liquid. As a result, the production of sediment caused by the solution hardening in the receptacle 53 can be suppressed without providing a separate liquid for re-dissolving the solute components.

When the liquid reservoir portion 73 is filled with the waste liquid produced by the suction cleaning, the solution wiped off by the scraper 70, and so on, the supernatant liquid of the solution held in the liquid reservoir portion 73 overflows into the discharge flow channel 45 via the liquid outflow port 56. By causing the liquid held in the liquid reservoir portion 73 to flow into the waste liquid collection flow channel 42 via the liquid outflow port 56, the lifespan of the receptacle 53 can be lengthened.

Meanwhile, solids that have not dissolved in the liquid are held within the liquid reservoir portion 73, which makes it difficult for solids to accumulate in the discharge flow channel 45 and inhibit the flow therein, makes it difficult for solids to clog the communication opening 47, and so on. Accordingly, the accumulation of solids in the waste liquid collection flow channel 42 can be suppressed.

Because the flushing unit 17 is disposed near the drying unit 14, the temperature around the receptacle 53 will rise due to the radiant heat radiated by the thermal unit 32, indicated by the dot-dash arrow lines in FIG. 2. Furthermore, the blower unit 33 blows air as indicated by the dotted line arrow in FIG. 2, and thus it is easy for the moisture in the solution to evaporate.

With respect to this point, the rotating member 51 is, aside from the upper surface side area thereof, housed within the containment chamber 68 along with the scraper 70 and the liquid reservoir portion 73. Furthermore, the opening 72 in the receptacle 53 is positioned lower, in the gravitational direction G, than the rotating member 51 and a tip of the scraper 70 that is pressed against the outer surface 50 of the rotating member 51. Accordingly, the interior of the containment chamber 68 is kept moist by the moisture that has evaporated from the liquid reservoir portion 73, and the scraper 70, the rotating member 51 aside from the upper surface side area thereof, and so on are suppressed from drying out. Accordingly, it is difficult for the solution to harden within the containment chamber 68. Furthermore, because the receptacle 53 is filled with new waste liquid each time the suction cleaning is executed, the concentration of solute in the liquid reservoir portion 73 is suppressed from rising.

According to the embodiment described thus far, the following effects can be achieved.

1. The solution adhering to the outer surface 50 as a result of the flushing can be removed by the first rotational operation of the rotating member 51. Note that the solution that has just adhered to the outer surface 50 due to the flushing sometimes flows between the scraper 70 and the outer surface 50 of the rotating member 51 rotating due to the first rotational operation, with a thin layer thereof remaining on the outer surface 50; this remaining solution will begin to harden as time passes. Accordingly, the solution not completely removed by the first rotational operation that remains on the outer surface 50 and begins to harden can be removed by the second rotational operation of the rotating member 51, which is executed after the first rotational operation has ended but before the next flushing is executed. Accordingly, the solution adhering to the rotating member 51 can be suppressed from accumulating.

2. Solution that is not completely removed by the first rotational operation and remains on the outer surface 50 after flushing and that begins to harden while the power is turned off can be removed by the rotating member 51 carrying out the second rotational operation when the power is turned on. Meanwhile, although the solution not completely removed by the first rotational operation often adheres and begins to harden at the point of contact between the outer surface 50 and the scraper 70, causing the rotating member 51 to carry out the second rotational operation when the power is turned on separates the scraper 70 and the outer surface 50 from each other. This makes it possible to rotate the rotating member 51 in a smooth manner when the first rotational operation is carried out after the next flushing.

3. In the first rotational operation performed after the flushing, the rotating member 51 rotates until the region that opposed the ejection head 23 during the flushing passes the scraper 70, and thus the solution ejected from the ejection head 23 and adhering to the outer surface 50 can be removed by the scraper 70 and held in the receptacle 53. Furthermore, in the second rotational operation, the rotating member 51 is rotated until the region that opposed the opening 72 when the first rotational operation ended reaches a position opposing the ejection head 23, and thus during the next flushing, the solution is ejected onto the region that has been kept in a moist state by the solvent of the solution held in the receptacle 53. As a result, the solution adhering to the outer surface 50 due to the next flushing can be removed with ease.

4. When a liquid in which the solute component of the solution can dissolve (waste liquid, for example) enters into the liquid reservoir portion 73 via the introduction portion 55, the amount of solvent component held in the receptacle 53 increases. As a result, the interior of the receptacle 53 is kept in a moist state by the solvent component, which in turn makes it possible to keep the outer surface 50 of the rotating member 51 that opposes the opening 72 in a moist state.

5. The rotating member 51 rotates when the liquid (waste liquid, for example) enters the receptacle 53, and thus foam that has reached the opening 72 adheres to the outer surface 50 of the rotating member 51. Foam that adheres to the outer surface 50 can be eliminated and the resulting liquid returns to the receptacle 53 by being wiped off by the scraper 70 as the rotating member 51 rotates. As a result, foam produced when the liquid enters can be suppressed from overflowing from the receptacle 53.

Note that the aforementioned embodiment may be modified as described hereinafter.

The amount by which the rotating member 51 rotates in the first rotational operation and the second rotational operation may be changed. For example, the processing of the same control routine as the first rotational operation may be executed, and the rotating member 51 may make a single rotation as a result, in the second rotational operation as well. However, because flushing is carried out after the second rotational operation, it is preferable to set the amount by which the rotating member 51 rotates in the second rotational operation so that the region thereof contained within the containment chamber 68 when the first rotational operation ended reaches a position opposing the ejection head 23. In this case, the region of the outer surface 50 contained within the containment chamber 68 has been kept in a moist state, and thus the solution adhering to the outer surface 50 in the next flushing can be removed with ease. Note that the dispositions, sizes, and so on of the ejection head 23, the rotating member 51, and the scraper 70 may be modified in order to realize such a configuration.

The timing at which the second rotational operation is carried out is not limited to when the power is turned on. For example, the second rotational operation may be carried out when the liquid ejecting apparatus 11 is turned off, when the liquid ejecting apparatus 11 enters or exits a power-saving mode, when printing has ended, or the like. By performing the second rotational operation when the power is turned off, when the apparatus enters a power-saving mode, or the like, a situation where the solution remaining on the outer surface 50 hardens and the scraper 70 adheres to the outer surface 50 due to the rotating member 51 being stopped for a long period of time can be suppressed from occurring.

The second rotational operation may be carried out a plurality of times between the first rotational operation and the next flushing.

During the third rotational operation, the control unit 100 may start and stop the driving of the suction pump and the flushing motor 57 at the same time. Alternatively, the driving of the flushing motor 57 may be started after a predetermined amount of time has elapsed following the driving of the suction pump 44 being started, the driving of the flushing motor 57 may be stopped after a predetermined amount of time has elapsed following the driving of the suction pump 44 being stopped, and so on.

A counter that counts an amount of time that has passed from when the flushing starts or from when the flushing ends may be provided. According to this configuration, the rotating member 51 can carry out the first rotational operation when a count value of the counter exceeds a first determination value, and the rotating member can carry out the second rotational operation when the count value of the counter exceeds a second determination value that is greater than the first determination value. Through this, the second determination value can be set to a value at which the liquid does not completely harden, and the solution can then be removed from the rotating member 51 by carrying out the second rotational operation before the liquid completely hardens.

Alternatively, the rotating member 51 may carry out the second rotational operation in the case where an amount of time that has elapsed following the end of the first rotational operation has exceeded a predetermined determination value.

It should be noted that in the case where the second rotational operation is carried out based on an amount of time that has elapsed following the end of the flushing or the first rotational operation, as in these variations, the second rotational operation is not carried out in the case where the period of time before the next flushing is carried out is shorter than the determination value. Accordingly, the second rotational operation can be carried out only when there is a long time until the next flushing is carried out and a resulting risk that the solution adhering to the rotating member 51 will harden.

The areas of the rotating member 51 aside from the upper surface that receives the solution, and the scraper 70, may be disposed within the liquid reservoir portion 73. According to this configuration, the solution that has adhered to and hardened on the upper surface of the rotating member 51 can be re-dissolved by the liquid held in the liquid reservoir portion 73 and wiped off by the scraper 70. Note that if the rotating member 51 is a cylindrical drum, rotational problems caused by the solute components adhering thereon will not easily occur even if the rotating member 51 is submerged in the solution within the liquid reservoir portion 73.

The scraper 70 is not limited to having a plate shape, and may instead be a band-shaped member configured of a belt, for example, that sandwiches the rotating member 51. According to this configuration, even in the case where part of the belt-shape rotating member 51 is disposed within the liquid reservoir portion 73, the solution can be suppressed from adhering on the inner circumferential surface of the belt.

One or both of the rotating member 51 and the scraper 70 may be configured of metal members. According to this configuration, the water that has evaporated from the solution will condense on the surface of the metal members exposed from the liquid reservoir portion 73 within the containment chamber 68, which is kept in a moist state; as a result, the solution can be suppressed from adhering on the metal members.

The holding frame 52 and the receptacle 53 may be formed as a single integrated member.

The suction mechanism 16 may be omitted from the configuration. Furthermore, the introduction flow channel 43 connected to the suction mechanism 16 may be omitted from the configuration. Even in such case, providing, for example, a flow channel that introduces a liquid containing a solvent component such as water into the liquid reservoir portion 73, mounting the receptacle 53 to the mounting portion 54 in a state where a liquid such as water is already in the liquid reservoir portion 73, and so on make it possible to hold a liquid into which the solute components of the solution can dissolve in the liquid reservoir portion 73. Note that holding water that does not contain the solute in the liquid reservoir portion 73 in advance makes it possible to increase the solubility of the hardened solute. Furthermore, the rotating member 51 may not carry out the third rotational operation in cases such as where the waste liquid is not introduced into the receptacle 53 via the introduction flow channel 43.

The drying unit 14 may be omitted from the configuration.

The configuration may be such that the scraper 70 is held by the holding frame 52. According to this configuration, the waste liquid held in the liquid reservoir portion 73 can be suppressed from adhering to the scraper 70.

The scraper 70 and the rotating member 51 may be disposed at the outside of the containment chamber 68.

The holding portion 74 may not include the biasing member 75.

The liquid outflow port 56 may not be provided in the receptacle 53.

The liquid outflow port 56 can also be provided within the liquid reservoir portion 73. In other words, the liquid reservoir portion 73 may not normally hold a liquid. Even in this case, solids in the solution held in the receptacle 53 can be dissolved each time the waste liquid is introduced into the liquid reservoir portion 73 via the introduction flow channel 43.

The liquid outflow port 56 may be provided in a base area of the liquid reservoir portion 73. In this case, providing a net or the like in the liquid outflow port 56 to suppress solids from flowing out makes it possible to suppress large solids from flowing out. According to this configuration, solute components that have sunk to the base area of the liquid reservoir portion 73 can be caused to flow out from the liquid outflow port 56.

The liquid ejecting apparatus may be what is known as a full-line type, in which a fixed ejection head that is long so as to match the overall width of the medium 12 is provided rather than the ejecting unit 13 including the carriage 21. In this case, a printing range of the ejection head may span the overall width of the medium 12 by disposing a plurality of unit head portions, in which nozzles are formed, in parallel, or the printing range may span the overall width of the medium 12 by disposing a plurality of nozzles in a single, long head so as to span the entire width of the medium 12.

The ejection head 23 may be configured to eject a solution that does not contain water.

The solution ejected by the ejection head 23 may be a fluid aside from ink (including liquids, a liquid state material in which the particles of a functional material are dispersed throughout or mixed with a liquid, fluids such as gels, and solids that can be flowed and ejected as fluids). For example, the liquid ejecting apparatus may be configured to record by ejecting fluids including materials such as electrode materials, coloring materials (pixel materials), and so on in a dispersed or dissolved state for use in the manufacture and so on of, for example, liquid-crystal displays, EL (electroluminescence) displays, surface emitting displays, and so on.

What is claimed is:

1. A liquid ejecting apparatus comprising:
an ejection head capable of ejecting a solution;
a rotating member having an outer surface capable of receiving the solution ejected from the ejection head; and
a scraper that wipes off the solution adhering to the outer surface by sliding along the outer surface when the rotating member rotates,
the rotating member carrying out a first rotational operation of rotating after flushing, in which the ejection head ejects the solution toward the outer surface, has been performed, and a second rotational operation of rotating from when the first rotational operation ends to when the next flushing is executed.

2. The liquid ejecting apparatus according to claim 1,
wherein the rotating member carries out the second rotational operation when the liquid ejecting apparatus is turned on.

3. The liquid ejecting apparatus according to claim 1, further comprising:
a receptacle having an opening in a position that opposes the outer surface,
wherein the solution wiped off from the outer surface by the scraper is held in the receptacle via the opening; and
as the first rotational operation, the rotating member rotates until at least a region that opposed the ejection head during the flushing passes the scraper, and as the second rotational operation, the rotating member rotates until a region that opposed the opening at the end of the first rotational operation reaches a position opposing the ejection head.

4. The liquid ejecting apparatus according to claim 3,
wherein the receptacle includes a liquid reservoir portion capable of holding a liquid and an introduction portion for introducing a liquid in which a solute component of the solution can be dissolved into the liquid reservoir portion.

5. The liquid ejecting apparatus according to claim 4,
wherein the introduction portion is disposed higher in a vertical direction than the liquid reservoir portion; and
the rotating member carries out a third rotational operation of rotating when the liquid enters the receptacle.

6. A control method for a liquid ejecting apparatus that includes an ejection head capable of ejecting a solution, a rotating member having an outer surface capable of receiving the solution ejected from the ejection head, and a scraper that wipes off the solution adhering to the outer surface by sliding along the outer surface when the rotating member rotates, the method comprising:
performing a first rotational operation in which the rotating member rotates after flushing, in which the ejection head ejects the solution toward the outer surface, has been performed; and
performing a second rotational operation in which the rotating member rotates from when the first rotational operation ends to when the next flushing is executed.

7. The control method for a liquid ejecting apparatus according to claim 6, including performing the second rotational operation when the liquid ejecting apparatus is turned on.
